(19) United States
(12) Patent Application Publication
(10) Pub. No.: US 2014/0263607 A1
(43) Pub. Date: Sep. 18, 2014

(54) SCANNABLE CODES TO DISPLAY MACHINE INFORMATION

(71) Applicant: CLARK EQUIPMENT COMPANY, West Fargo, ND (US)

(72) Inventors: Spencer L. Mindeman, West Fargo, ND (US); Scott R. Rossow, Kindred, ND (US)

(73) Assignee: CLARK EQUIPMENT COMPANY, West Fargo, ND (US)

(21) Appl. No.: 13/838,252

(22) Filed: Mar. 15, 2013

(51) Int. Cl. G06F 17/30

(52) U.S. Cl. CPC G06F 17/30
USPC 235/375

(57) ABSTRACT

Disclosed embodiments include methods, systems and apparatus for providing power machine and/or implement information. In disclosed methods, which can be implemented using power machine controllers and display devices, information relating to the power machine or implement can be provided and instructional information can be accessed from a website or otherwise from a computer located remotely. A scannable code is generated such that it is embedded with information relating to one of the power machine and an implement coupled to the power machine, with the information including an operating condition component or dynamic information component unique to the power machine at a particular point in time. The code is displayed on a display device. When scanned by a personal mobile computing device, the code causes the computing device to access a website and provide the operating condition or dynamic information component to the website.

### BACKGROUND

This disclosure is directed towards power machines. More particularly, this disclosure is directed toward accessing and providing information about a power machine to an operator, technician, or other persons that may benefit from such information. Power machines, for the purposes of this disclosure, include any type of machine that generates power for the purpose of accomplishing a particular task or a variety of tasks. One type of power machine is a work vehicle. Work vehicles are generally self-propelled vehicles that have a work device, such as a lift arm (although some work vehicles can have other work devices) that can be manipulated to perform a work function. Some examples of work vehicle power machines include loaders, excavators, utility vehicles, tractors, and trenchers, to name a few.

Some power machines can be operably coupled to implements that are capable of cooperating with the power machine to perform various tasks. For example, some loaders have lift arms that are capable of having a wide variety of implements operably coupled to them, ranging from a simple bucket or blade to relatively complex implements, such as planers and graders, that have work devices capable of performing various tasks. Some of these work devices on implements are controllable by operator input devices on the power machines to which they are operably coupled.

The discussion above is merely provided for general background information and is not intended to be used as an aid in determining the scope of the claimed subject matter.

### SUMMARY

Disclosed embodiments include methods, systems and apparatus for providing power machine and/or implement information. In disclosed methods, which can be implemented using power machine controllers and display devices, information relating to the power machine or implement can be provided and instructional information can be accessed from a website or otherwise from a computer located remotely. A scannable code is generated such that it is embedded with information relating to one of the power machine and an implement coupled to the power machine, with the information including an operating condition component or dynamic information component unique to the power machine at a particular point in time. The code is displayed on a display device. When scanned by a personal mobile computing device, the code causes the computing device to access a website and provide the operating condition or dynamic information component to the website.

In exemplary embodiments, the operating condition component or dynamic information which is embedded in the scannable code includes parameters such as hour meter readings, current fault codes, temperatures, pressures, or other measured parameters which can be used by a diagnostic program to provide diagnostic information for the power machine or implement. The scannable code can also include a static component which identifies the power machine or implement type, model, serial number or other information. This information can be used to automatically retrieve, using a personal mobile computing device to scan the code, operating manuals or other such information.

This Summary and the Abstract are provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a side elevation view of a power machine having a controller configured to generate scannable codes with embedded dynamic information in accordance with disclosed embodiments.

FIG. 2 is a block diagram illustrating components of the power machine of FIG. 1 and a coupled implement.

FIG. 3 is block diagram illustrating information to be stored in a generated code according to one illustrative embodiment.

FIG. 4 is a diagrammatic illustration of a power machine display device displaying one illustrative example of a scannable code and a personal mobile computing device configured to read the code and access information from a remote computer.

FIG. 5 is a diagrammatic illustration of a power machine display device displaying another illustrative example of a scannable code.

FIGS. 6 and 7 are flow diagrams illustrating exemplary method embodiments.

### DETAILED DESCRIPTION

The concepts disclosed in this discussion are described and illustrated with reference to exemplary embodiments. These concepts, however, are not limited in their application to the details of construction and the arrangement of components in the illustrative embodiments and are capable of being practiced or being carried out in various other ways. The terminology in this document is used for the purpose of description and should not be regarded as limiting. Words such as “including,” “comprising,” and “having” and variations thereof as used herein are meant to encompass the items listed thereafter, equivalents thereof, as well as additional items.

The embodiments discussed below are directed toward power machines and systems on power machines that provide information related to the power machine and/or any implement that is operably coupled to the power machine. In particular, the embodiments discussed below are related to electrical and electronic components related to the collection and dissemination of such information and the forms in which this information is disseminated. Information in the disclosed embodiment is provided in the form of scannable codes that are readable by a device external to the power machine. The embodiments discussed below are discussed in terms of a power machine generally, and those skilled in the art will appreciate that the disclosed embodiments can be practiced on any of a number of different types of power machines and are not intended to be limited in application to any one type of power machine. For the purposes of this discussion, a representative power machine on which the embodiments can be practiced is illustrated in FIG. 1 and described below before any embodiments are disclosed. For the sake of brevity, only one representative power machine is discussed. However, as mentioned above, the embodiments below can be practiced on any of a number of power machines, including power machines of different types from the representative power machine discussed below.

FIG. 1 is a side elevation view of a representative power machine 100 upon which the disclosed embodiments can be employed. While certain features of power machine 100 are discussed here, other power machines have other features besides those discussed with regard to power machine 100 or variations of the features of power machines on which the disclosed embodiments can be practiced. The representative power machine 100 illustrated in FIG. 1 is a work vehicle in the form of a loader and more particularly, a skid steer loader. However, the concepts discussed below can be practiced on many other types of work vehicles such as tracked loaders, steerable wheeled loaders, including all-wheel steer loaders, excavators, telehandlers, walk behind loaders, trenchers, and utility vehicles, to name but a few examples as well as many other different types of power machines as well. The power machine 100 includes a supporting frame or main frame 102 that supports a power source 104 such as an internal combustion engine. A power conversion system 106 is operably coupled to the power source 104. Power conversion system 106 illustratively receives power from the power source 104 and operator inputs to convert the received power to power signals in a form that is provided to and utilized by functional components of the power machine.

In some power machines, including the power machine 100 in FIG. 1, the power conversion system 106 includes hydraulic components such as one or more hydraulic pumps, various actuators, and other components that are illustratively employed to receive and selectively provide power signals in the form of pressurized hydraulic fluid to some or all of the actuators used to control functional components of the power machine 100. For example, a control valve assembly (not separately shown) is used to selectively provide pressurized hydraulic fluid from a hydraulic pump to actuators such as hydraulic cylinders that are positioned on the power machine. Power conversion system 106 also selectively provides pressurized hydraulic fluid, to a port 134, to which an implement can be coupled for receiving pressurized hydraulic fluid.

Other power machines upon which the disclosed embodiments can be practiced can employ other power conversion systems. For example, some power machines have power conversion systems that include electric generators or the like to generate electrical control signals to power electric actuators. Still other power machines have mechanical transmissions that act as a power conversion system, at least so far as a drive system is concerned. For the sake of simplicity, the actuators discussed in the disclosed embodiments herein are referred to as hydraulic or electrohydraulic actuators, but other types of actuators can be employed in some embodiments.

Among the functional components that are capable of receiving power signals from the power conversion system 106 are tractive elements 108, illustratively shown as wheels, which are configured to rotatably engage a support surface to cause the power machine to travel. Other examples of power machines can have tracks or other tractive elements instead of wheels. Power machine 100 has a pair of hydraulic motors (not shown in FIG. 1) that convert a hydraulic power signal into a rotational output. In some power machines, such as skid steer loaders including power machine 100, a single hydraulic motor is operably coupled to all of the tractive elements on one side of the power machine. Other power machines have, a hydraulic motor provided for each of its tractive elements. Still other machines have a single drive motor that is operably coupled to every driven tractive element. In a skid steer loader, such as power machine 100, steering is accomplished by providing unequal rotational outputs to the tractive element or elements on one side of the machine as opposed to the other side to cause the loader to skid across a support surface. In some power machines, steering is accomplished through other means, such as, for example, steerable axles.

The power machine 100 also includes a lift arm structure 114 that is capable of being raised and lowered with respect to the frame 102. The lift arm structure 114 illustratively includes a lift arm 116 that is pivotally coupled to the frame 102 at pivotable joint 118. An actuator 120, which in some embodiments is a hydraulic cylinder configured to receive pressurized fluid from power conversion system 106, is pivotally coupled to both the frame 102 and the lift arm 116 at pivotable joints 122 and 124, respectively. Actuator 120 is sometimes referred to as a lift cylinder. Extension and retraction of the actuator 120 causes the lift arm 116 to pivot about pivotable joint 118 and thereby be raised and lowered along a generally vertical path indicated approximately by arrow 138. The lift arm 116 is representative of the type of lift arm that may be coupled to the power machine 100. The lift arm structure 114 shown in FIG. 1 includes a second lift arm and actuator disposed on an opposite side of the of the power machine 100, although neither is shown in FIG. 1. Other lift arm structures, with different geometries, components, and arrangements can be coupled to the power machine 100 or other power machines upon which the embodiments discussed herein can be practiced without departing from the scope of the present discussion.

An implement attachment apparatus in the form of an implement carrier 130 is pivotally coupled to the lift arm 116 at pivotable joint 132. An implement attachment apparatus, for the purposes of this discussion, is an attachment mechanism for attaching an implement to a power machine. On some power machines, implements are attached directly to the machine and thus the implement attachment apparatus can include, for example, a mounting feature and a mounting pin that engages the mounting feature to attach the implement to the power machine. However, as mentioned above, the power machine has an implement carrier 130, which is configured to accept and secure any one of a plurality of different types of implements thereto. By having an implement carrier capable of being attached to a plurality of different implements, changing from one implement to another can be accomplished with relative ease. For example, machines with implement carriers can provide an actuator between the implement carrier and the lift arm, so that removing or attaching an implement does not involve removing or attaching an actuator from the implement. The implement carrier 130 provides a mounting structure for easily attaching an implement to the lift arm (or other portion of a power machine) that a lift arm without an implement carrier does not have.

One or more actuators such as hydraulic cylinder 136 are pivotally coupled to the implement carrier and the lift arm structure 114 to cause the implement carrier to rotate under power about an axis that extends through the pivotable joint 132 in an arc approximated by arrow 128 in response to operator input. In some embodiments, the one or more actuators pivotally coupled to the implement carrier and the lift arm assembly are hydraulic cylinders capable of receiving pressurized hydraulic fluid from the power conversion system 106. The one or more hydraulic cylinders 136 are sometimes referred to as tilt cylinders. As mentioned above, the implement carrier 130 is configured to accept and secure any one of a number of different implements to the power machine 100 as may be desired to accomplish a particular work task.

Power machine 100 provides a source, accessible at port 134 mentioned above, of power and control signals that is made available for coupling to an implement to control various functions on such an implement, in response to operator inputs. In one embodiment, port 134 includes hydraulic couplers that are connectable to an implement for providing power signals in the form of pressurized fluid provided by the power conversion system 106 for use by the implement. Alternatively or in addition, port 134 includes electrical connectors that can provide power signals and control signals to the implement to control and enable actuators of the type described above to control operation of functional components on the implement.

Power machine 100 also illustratively includes a cab 140 that is supported by the frame 102 and defines, at least in part, an operator compartment 142. Operator compartment 142 typically includes an operator seat (not shown) and operator input devices (not shown in FIG. 1) and display devices (not shown in FIG. 1) accessible and viewable from a sitting position in the seat. When an operator is seated properly within the operator compartment 142, the operator can manipulate operator input devices to control such functions as driving the power machine 100, raising and lowering the lift arm structure 114, rotating the implement carrier 130 about the lift arm structure 114 and make power and control signals available to an implement via the sources available at port 134. An electronic controller 150 is provided for receiving inputs from operator input devices and providing control signals to functional devices on the power machine 100.

FIG. 2 provides a simplified block diagram illustration of a power machine 200 and an attachable implement 300 that is operably coupled to the power machine 200. The power machine 200 is capable of providing information related to the power machine 200 and/or the attached implement 300 in the form of a scannable code according to one illustrative embodiment. Power machine 200 can be a skid steer loader (as is shown in FIG. 1) or any other work vehicle or, more generally, any other power machine. Power machine 200 has a power source 204 that provides a power output to a power conversation system 206 for controlling functional components on the power machine. An electronic controller 250 is provided for controlling various functions on and collecting information about the power machine 200. The electronic controller 250 includes a processor and memory including instructions that, when executed, perform control and data collection operations, as well store information about the power machine and real-time operating conditions on the power machine in the memory of the electronic controller 250. In addition, the electronic controller 250 is in communication with a display device 220 and is capable of providing information to the display device for controlling at least some aspects of information that is displayed to an operator. The display device 220 includes a programmable display panel 222 and control circuitry 224 that is in communication with the programmable display panel for rendering the information displayed thereon. The display device 220 can also include various other programmable and non-programmable display components. The control circuitry 224 is also in communication with the electronic controller 250 for receiving information related to what should be rendered for display on the programmable display panel 222. The electronic controller 250 can be implemented in a single controller, or in a plurality of controllers that are in communication with each other. The display device 220 can be one or more discrete packages, separate from any controllers that may be included in electronic controller 250. Alternatively, one or more packages that are included in the display device can also house some or all of the electronic controller 250. Electronic controller 250 and display device 220, then, are described in terms of functionality. These functions can be implemented in a number of different components and configurations.

Electronic controller 250 is shown in communication with power source 204 via communication line 230 and power conversion system 206 via communication line 232. In addition, a communication line 236 is provided from the electronic controller 250 to port 234 for attachment to implement 300. Communication with power source 204 can be via a power source controller 240 (which in some embodiments is an engine controller for controlling an internal combustion engine) or directly with components on the power source. Communication with power conversion system 206 includes, in some embodiments, communication with components such as actuators related to pumps, valves, motors, and the like. In addition to containing control components in some embodiments, the communication signals 230, 232 and/or 236 can also include status information from the power source 204, power conversion system 206 and/or implement 300 to communicate status or current operational information to electronic controller 250. For example, status information can be provided from a power source controller 240 of power source 204 or an implement controller 302 of implement 300. Status information can also be derived from one or more of power source 204, power conversion system 206 and implement 300, for example based on responsiveness to control signals, etc. Any number of devices can be in communication with electronic controller 250 besides those shown in FIG. 2. For example, various diagnostic sensors that provide signals of sensed temperatures, pressures, positions and the like can be in communication with electronic controller 250.

FIG. 2 also shows that electronic controller 250 is in communication with one or more operator input devices, represented collectively by operator input devices 210. Operator input devices 210 include various actuable switches, buttons, levers, including input devices that are part of a display package, including switches positioned adjacent display devices and touch screen display devices, and the like that an operator can manipulate to indicate control intentions. The operator input devices 210 provide signals indicative of their actuation state. Any number and type of operator input devices can be operably coupled to electronic controller 250 such as by a wired connection directly from the operator input devices, by serial communication on a data bus with which the electronic controller and one or more operator input devices are in communication, by wireless communication between one or more operator input devices and the electronic controller, or any combination of these operable couplings or any other appropriate coupling. Operator input devices 210, in various embodiments, can be used to control various functions related to operation of power machine 200 and implement 300. For example, operator input devices can be used to control a drive system on a power machine or a work device such as a lift arm. In addition, operator input devices 210 can be used to control functions on complex implements that are operably coupled power machine 200.

Implement 300 shown in FIG. 2 is a complex implement as opposed to a simple implement such as a bucket, which can also be coupled to power machine 200. Complex implements such as implement 300, for the purposes of this discussion, include an implement controller 302 that is operably coupled to and controls one or more actuation devices 304 on the implement. In various embodiments, different complex implements can be coupled to power machine 200 and different complex implements can be controlled differently than other complex implements. More particularly, one or more operator input devices 210 may be used to control functions on one complex implement and the same (or different) operator input devices may be used to control different functions on a second complex implement. Due to the flexibility of this arrangement, namely, that a single power machine can be used to control different implements, new and different implements suitable for use with a given power machine are being developed on an ongoing basis. An operator may wish to use an implement with which he or she is not familiar and thus may need instruction. Because complex implements are being developed on an ongoing basis and independent of power machines, the implement itself may have been developed after the power machine was developed. Implement 300 also optionally includes a display device 306 and/or implement operator input devices 308 in communication with the implement controller 302, although several embodiments include neither. Display device 306, in some embodiments, includes a programmable display panel similar to programmable display panel 222. Implement operator input devices 308 are manipulable by an operator to control functions on the implement 300 and/or the power machine 200. For example, implement operator inputs can include a keyswitch that is operable to start and stop the power machine and other inputs to control functions on the implement. These implement operator input devices 308 are illustratively provided to an implement controller 302, which in turn communicates their status to electronic controller 250, as required. An example of an implement with implement operator input devices such as those described here is discussed in U.S. Pat. No. 6,030,169 of Rossow et al., incorporated by reference in its entirety.

When implement 300 is operably coupled to power machine 200, such as, for example, by connection to the power machine 200 at port 234, the implement controller 302 is in communication with controller 250 and the one or more actuation devices 304 are in communication with power conversion system 206. In some embodiments, power conversion system 206 provides a power signal in the form of hydraulic fluid for selectively providing power to implement controller 302. Implement controller 302 provides information to the electronic controller 250, including identification information that indicates what type of complex implement that implement 300 is. In addition, implement controller 302 receives information from electronic controller 250 indicative of which operator input devices 210 that are generally used for control of implements 300 have been actuated. Based on that information, implement controller 302 cooperates with electronic controller 250 to ensure that proper control signals, such as pressurized hydraulic fluid, are provided from the power machine 200 to the implement 300 and directed to the proper actuation devices 304.

Because an operator may not be familiar with the operation of a particular implement and because new implement are being designed on an ongoing basis, such that instruction tutorials onboard the machine may not be practicable, in the present embodiment, a system and method for providing access to remotely accessible tutorials to an operator are provided. Information about the power machine 200 and the implement 300 are collected and embedded in a scannable code generated by the electronic controller 250 and displayed on the programmable display panel 222.

Information about the pairing of power machine 200 and implement 300 is one example of information that can be collected and stored in a generated scannable code and then displayed on programmable display panel 222. FIG. 3 illustrates an information model 350 that provides a framework for information that is collected for inclusion in a scannable code according to one illustrative embodiment. The information model 350 illustratively includes two portions and in some embodiments, a third portion. The first portion of the information model 350 is a static component 352 and the second portion of the information model 350 is a dynamic component 354. The static component 352 includes information that is static, that is, not varied from one code generated on a particular machine from another. For example, in one embodiment, the static information identifies the power machine on which the code is being generated. The static information can be in the form of a model number, or a particular type of power machine, a particular type and version of a power machine, or a serial number of a particular power machine. This information is provided for any scannable code generated by that particular power machine.

The dynamic component 354 includes information related to information specific to a particular scannable code. In the example discussed above, a scannable code would be generated for remotely accessing a tutorial online. For the most part, the specific information collected as dynamic information for an operational tutorial (as opposed to a troubleshooting tutorial) is generally similar. For example, in tutorials for operation of an implement, the dynamic component 354 primarily illustratively includes implement identification information that indicates what implement that is operably coupled to the power machine 200 (or in some cases, discussed in more detail below, of an implement selected from a pre-defined list, even if such an implement is not operably coupled to power machine 200). The implement identification information can include the type of implement that is attached in the form of a model number, or more particularly a serial number that identifies not only the type of implement, but the exact implement that is attached. In addition, the dynamic information can include information about software versions loaded on electronic controller 250, implement controller 302, and any accessories or options present on the power machine 200 or implement 300 that can affect operation of the implement 300. However, in tutorials related to troubleshooting, the dynamic component 354 can vary based on what component or system on the power machine 200 is to be troubleshot. Thus, while the overall framework of the model, i.e., having static and dynamic components (and as described below, an optional remote identification component) is generally similar no matter what is being generated, in the case troubleshooting, the specific information to be collected can vary from one troubleshooting application to the next. Thus, while there is a single model or, at most, a very limited number of models related to operational tutorials, each troubleshooting related code can have a different model.

FIG. 3 also illustrates an option remote identification component 356 portion of the information model 350. The remote identification component includes, in one embodiment, an address of a routine that is capable of providing information related to the code that is being generated. For example, in the case of a scannable code that is being generated to access a remote tutorial, the remote identification component can include a URL address where remote tutorials can be accessed or, more particularly, where a remote tutorial for a particular tutorial can be accessed. Alternatively, the remote identification component 356 can identify a particular tutorial to access or identify the code itself and allow a remote site to determine what that particular type of information is to be accessed, given that code.

The example above refers to one embodiment of a code generation related to a tutorial for a given implement. As discussed above, codes are also generated for accessing remote troubleshooting routines for addressing a potential service issue related to diagnostic information stored on electronic controller 250. Referring to the general information model 350, the static information component 352 would be consistent from one code to another, as the static information does not change from one troubleshooting code to another. The dynamic component 354 for each troubleshooting model illustratively includes information related to a specific diagnostic condition, such as stored fault codes, elapsed time on the machine and real time sensor readings related to the stored fault codes, as well as any other information that would be helpful to a troubleshooting application. Because the amount of data storable in such codes is limited, and because different fault code troubleshooting routines would benefit from different information, creating different models, specifically, creating different dynamic component models for each troubleshooting routine, provides that as much relevant data as possible can be included in a generated code. In addition, the scannable code also includes a remote identification component 356 in some embodiments. In one embodiment, the electronic controller 250 generates a Quick Response (QR) code that can be read by a QR code scanning module on a smart phone or other mobile computing device from the data collected according to the information model 350. Alternatively, the electronic controller can generate a bar code or other graphical based code for encoding data in a manner that can be scanned with a personal mobile computing device such as a smart phone.

FIG. 4 shows an embodiment of display device 220 showing programmable display panel 222 and a plurality of display user inputs 226 that are in communication with the control circuitry 224 (as shown in FIG. 2). The display user inputs 226 are provided for allowing an operator to respond to display prompts and enter information on the display panel 222. Programmable display panel 222 in FIG. 4 illustrates text related to an implement and a scannable code 260 displayed thereon. In this example, the display panel 222 indicates that the code 260 can be scanned to access online operating instructions.

The screen shown in FIG. 4 can be accessed on the display panel 222 through a menu driven arrangement incorporating the display user inputs 226, or, in alternate embodiments, where display panel 222 is a touch screen, through display user inputs on the display panel 222. The screen prompting for a planer tutorial can be reached when the implement 300 attached to the power machine is a planer and the electronic controller 250 receives information about the planer from the implement controller 302. In some embodiments, the control circuitry 224 or the electronic controller 250 can have a collection of codes generated for known implements that can be accessed even if the implement is not attached to the power machine 200. Thus, a similar screen arrangement as is shown in FIG. 4 can be provided via a code generated without accessing a particular implement. Of course, such a list would be limited to known implements, whereas a code generated by accessing information from an electronic controller on an attached implement would have no such limitation. The code generation and display is disclosed with reference to electronic controller 250 and display device 220, in some embodiments, such a code can be generated by implement controller 302 and displayed on display device 306 on implement 300.

A mobile computing device 320 that can scan the code 260 is shown in FIG. 4. Mobile computing device 320 preferably has connectivity to the Internet or other similar network. By accessing this information over Internet 344 or other computer networks providing access to remote computers, it is no longer necessary for all of the desired information to reside in memory on the power machine 200 or implement 300. In addition to reducing storage requirements, processing power requirements, and the like, this system lessens the burden of updating information for a large number of implements, updating diagnostic routines, etc. For example, the user may be attempting to access manuals explaining which operator input devices on power machine 200 control which planer functions. Disclosed embodiments provide a system for accessing information from a remote location, such as remote computer 348, utilizing devices such as smart phones or similar mobile computing devices 320 with Internet connectivity. While using a mobile computing device to scan the code and access a remote server (as discussed below) is advantageous in that such a device can be used almost anywhere, in practice, any device, mobile or not, capable of scanning code 260 and accessing a remote server can be used. Whatever device is being used to scan the code will also be able to access software that is capable of scanning the code 260, recognizing the encoded contents, and initiate access to the appropriate remote server.

Mobile computing device 320 includes a lens 332, such as a camera lens, which can be used to view scannable code 260. A resulting image 336, which can be representative of an image data file from an image sensor in a particular state of processing light from image 260, is provided to a processor 324 of the mobile computing device 320. Processor 324 is configured to utilize a code reading program or routine to decode the image 336 to extract data, in the form of decoded data 326, from the image. Decoded data 326 includes the data stored in the code 260, described in information model 350 of FIG. 3 as the static component 352, dynamic component 354, and, optionally, the remote identification component 356. With this data, the mobile computing device 320 initiates communication with remote computer 348 via communication circuitry 340 of the mobile computing device then accesses the desired tutorial information from remote computer 348 over Internet 344 or similar computer networks. The tutorial information 370 is then provided to processor 324 in a form that causes it to be displayed on a screen or display device 328 of the mobile computing device.

FIG. 5 illustrates another example of a display device 220′ displaying information and a generated code 260′. In this example, the display device 220′ is indicating that a high engine coolant temperature fault code is or was active. The operator is prompted to scan the code to access online troubleshooting assistance. The screen shown in display device, in some embodiments, is shown whenever a given fault situation is active. Alternatively, the screen may be recalled at a later point in time from a menu driven application in response to actuation of display user inputs 226′. The code 260′ is generated by collecting the data according to an information model related to that particular fault code to include a static component, dynamic component, and optionally, a remote identification component. That is, each fault code has an informational model stored in the electronic controller 250 and when a fault code becomes active, a code is generated for display, either at the time of the fault or at a later point in time.

Referring now to FIG. 6, shown is a method 400 of providing information related to a power machine in accordance with embodiments described above and shown in FIG. 4. As shown at block 404, the method 400 includes the step of generating a code 260. Generating code 260 illustratively includes collecting static information and relevant dynamic information. The relevant dynamic information is acquired according to an informational model. As discussed above, codes for providing access to operational instruction tutorials are generated according to an informational model that provides, among other things, identification information related to the implement for which the tutorial is being provided. Codes generated for providing access to troubleshooting routines, are generated according an information model relevant to the particular system that is to be troubleshot. For example, the information model for a particular troubleshooting routine can require that the dynamic information component include information indicative of an hour meter reading, current fault codes registered, or measured parameters such as temperatures, pressures, or any sensed parameter as may be relevant. Next, as shown at block 408, the method further includes displaying the generated code on a display device 220 of the power machine in a form scannable by a personal mobile computing device 320 to extract the static and dynamic information.

A method 500 by which instructional information related to a power machine can be accessed is shown in FIG. 7 and is discussed below with additional reference to FIG. 4. As shown at block 504, the method of FIG. 7 includes generating a scannable code 260 with embedding information relating to the power machine and/or an implement coupled to the power machine. The embedded information includes an operating condition component indicative of an operating condition of the one of the power machine and the implement. As shown at blocks 508 and 512, the method 500 further includes displaying the code on a display device and scanning the code with a personal mobile computing device 320. Additionally, the method 500 includes, as shown at block 516, accessing a website with the personal mobile computing device, in response to scanning of the code. The mobile computing device provides the operating condition component information embedded in the scannable code to the website.

Although the present invention has been described with reference to preferred embodiments, workers skilled in the art will recognize that changes may be made in form and detail without departing from the scope of the discussion.

What is claimed is:

1. A method of accessing instructional information related to a power machine, comprising:
generating a scannable code including embedding information relating to one of the power machine and an implement coupled to the power machine, the information including an operating condition component;
displaying the code on a display device;
scanning the code with a personal mobile computing device; and
accessing a website with the personal mobile computing device, in response to scanning of the code, including providing the operating condition component information embedded in the scannable code to the website.

2. The method of claim 1, wherein generating the scannable code further comprises generating the scannable code with a controller on the power machine, and wherein displaying the code further comprises displaying the code on a display device on the power machine.

3. The method of claim 1, wherein generating the scannable code further comprises generating a quick response (QR) code embedded with the operating condition component.

4. The method of claim 1, wherein the operating condition component comprises dynamic information indicative of power machine performance, unique to the particular power machine at a given point in time.

5. The method of claim 4, wherein the dynamic information of the operating condition component comprises at least one of an hour meter reading, a fault code, a measured parameter, a temperature and a pressure.

6. The method of claim 4, wherein generating the scannable code further includes embedding static information identifying the power machine or the implement.

7. The method of claim 1, wherein accessing the website with the personal mobile computing device, in response to scanning of the code, further includes accessing diagnostic information based on the operating condition component.

8. A method of providing information related to a power machine, the method comprising:
generating a code having a static information component and a dynamic information component embedded therein, the dynamic information component being indicative of an operating parameter unique to the power machine at a particular point in time; and
displaying the code on a display device of the power machine in a form scannable by a personal mobile computing device to extract the static and dynamic information.

9. The method of claim 8, wherein generating the code having the static information component and the dynamic information component embedded therein further comprises generating a quick response (QR) code embedded with the static information component and the dynamic information component.

10. The method of claim 8, wherein generating the code having the static information component and the dynamic information component embedded therein further comprises generating the code embedded with dynamic information including at least one of an hour meter reading, a fault code, a measured parameter, a temperature and a pressure.

11. The method of claim 8, wherein generating the code having the static information component and the dynamic information component embedded therein further comprises generating the code embedded with static information identifying the power machine or an implement coupled to the power machine.

12. A power machine comprising:
a frame;
a power source supported by the frame;
a power conversion system coupled to the power source and supported by the frame, the power conversion system configured to convert power from the power source for use in effecting power machine travel and performing work functions;
a display device;
a machine controller operably coupled to the display device and configured to generate a code embedding information relating to a real-time operating parameter of the power machine, the machine controller configured to cause the display device to display the generated code in a form scannable by a personal mobile computing device to extract the real-time operating parameter.

13. The power machine of claim 12, wherein the machine controller is configured to generate a quick response (QR) code embedding the information relating to the real-time operating parameter of the power machine and to cause the display device to display the generated QR code.

14. The power machine of claim 12, wherein the machine controller is configured to generate the code embedding the information relating to the real-time operating parameter of the power machine in a form scannable by a personal mobile computing device to cause the personal mobile computing device to access a website and provide the real-time operating parameter to the website.

15. The power machine of claim 12, wherein the real-time operating parameter of the power machine comprises at least one of an hour meter reading, a fault code, a measured parameter, a temperature and a pressure.
